(19) United States
(12) Patent Application Publication
(10) Pub. No.: US 2026/0286930 A1
(43) Pub. Date: Sep. 24, 2026

(54) DEVICE FOR AVOIDING INDUCED ROTOR BLADE OSCILLATIONS OF A ROTOR BLADE OF A WIND TURBINE AND METHOD

(71) Applicant: Wobben Properties GmbH, Aurich (DE)

(72) Inventors: Jochen STEMBERG, Aurich (DE); Matthias ARNOLD, Aurich (DE)

(21) Appl. No.: 19/572,634

(22) Filed: Mar. 19, 2026

(30) Foreign Application Priority Data
Mar. 20, 2025 (EP) 25164977.8

(51) Int. Cl. F03D 1/06

(52) U.S. Cl. CPC F03D 1/06495; F05B 2240/3042

(57) ABSTRACT

The present disclosure relates to a device for avoiding induced rotor blade oscillations of a rotor blade of a wind turbine and a method for temporarily fastening a device for avoiding induced rotor blade oscillations to a rotor blade of a wind turbine. The device for avoiding induced rotor blade oscillations of a rotor blade of a wind turbine comprises two rope sections which are configured to act as a disturbing edge in a mounted state in which the device is mounted on the rotor blade, wherein the two rope sections are connected to one another at a plurality of connection points spaced apart from one another and in each case at least one of a plurality of fastening means is arranged on the disturbing edge between in each case two adjacent connection points.

### TECHNICAL FIELD

The present disclosure relates to a device for avoiding induced rotor blade oscillations of a rotor blade of a wind turbine and a method for temporarily fastening a device for avoiding induced rotor blade oscillations to a rotor blade of a wind turbine.

### BACKGROUND

Wind turbines are known. In addition to the tower and the nacelle, they comprise a rotor with several aerodynamic rotor blades. With a suitable incident wind flow, these generate a lift which leads to a rotation of the rotor, which in turn serves a generator for generating electricity. With an incident wind flow, oscillations are induced at the various components of the wind turbine, in particular the aerodynamically active rotor blades, which lead to additional loading and damage to components of the wind turbine. This is particularly problematic in the case of a turbine that stands still. For example, it was recognized that in the case of a turbine that stands still and a specific incident angle of the wind on the rotor, pivoting oscillations occur at the rotor blades. During normal operation of the turbine, such pivoting oscillations can be reliably avoided by pitching the blades and rotating the rotor out of the wind (yaw). This solution is not possible in the case of a turbine in construction in which neither pitch nor yaw can be reliably used, since the turbine control is not yet active.

Therefore, a solution is sought that reliably protects the blades from aerodynamically excited pivoting oscillations, without being dependent on the turbine control.

### SUMMARY

According to a first aspect of the invention, the object is achieved by a device for avoiding induced rotor blade oscillations of a rotor blade of a wind turbine, wherein the rotor blade extends from a rotor blade root in the rotor blade longitudinal direction with a rotor blade length to the rotor blade tip and from a rotor blade leading edge with a rotor blade chord in the rotor blade chord direction perpendicular to the rotor blade longitudinal direction to a rotor blade trailing edge and has a suction side and a pressure side, comprising two rope sections which are configured to act as a disturbing edge in a mounted state in which the device is mounted on the rotor blade, a fastening arrangement comprising a plurality of fastening means, wherein the disturbing edge is configured to be attachable in a region of the rotor blade leading edge, the two rope sections are connected to one another at a plurality of connection points spaced apart from one another and in each case at least one of the plurality of fastening means is arranged on the disturbing edge between in each case two adjacent connection points, wherein the fastening arrangement is configured to span the two rope sections in the mounted state in the rotor blade chord direction and to fasten, in one example temporarily fasten, the disturbing edge in the region of the rotor blade leading edge.

The present disclosure serves for avoiding rotor blade oscillations during the construction of wind turbines, for example in the case of single blade mounting and for semi-constructed states. The present disclosure is applicable to states and times at which the pitch and/or yaw drive of the turbine cannot be used, for example on account of a lack of energy supply, incomplete rotor blade fastening, and in the case of a collision or movement conflict with an installation crane or equipment. In one example, the present disclosure avoids or sufficiently reduces pivoting oscillations in the direction of the leading or trailing edge of the rotor blade. A sufficient reduction of the pivoting oscillations is manifested, for example, in the fact that the excitations are smaller than the structural or aerodynamic inherent damping of the rotor blade. A critical swing-up oscillation is then no longer possible.

In this case, the present disclosure provides a device which can be attached reversibly to a rotor blade and which brings about a reversible change in the outer geometry of the rotor blade in a targeted manner. This change in the outer geometry has an effect on the aerodynamics of the rotor blade such that the aerodynamic excitation of pivoting oscillations is avoided.

A device according to the present disclosure expediently serves for avoiding induced rotor blade oscillations. In this case, these rotor blade oscillations are induced by an incident wind flow. An example of rotor blade oscillations are pivoting oscillations in the direction of the leading or trailing edge of the rotor blade. In this case, it is not necessary for a device according to the present disclosure to suppress every oscillation and for the rotor blade to be in a completely still state. It is sufficient for oscillations to be reduced such that there is no positive resonance or interference with further oscillations which could bring about oscillations with a dimension which has a negative effect on the loading and/or safety of the rotor blade. Such rotor blade oscillations are avoided by a device according to the present disclosure.

A device according to the present disclosure comprises two rope sections. These can be part of a rope, or else two parts of two ropes.

The mounted state describes a state in which the device is mounted on the rotor blade in an appropriate and expedient manner. Mounted in this case describes that the device is arranged and attached, preferably also fastened, to the rotor blade. Preferably, this mounting is configured reversibly in such a way that, after the mounting has been released, the rotor blade has a substantially identical state as before the mounting. Substantially identical in this case means that, for example, minimal adhesive residues during mounting by adhesive are dispensed with. In exemplary embodiments, the mounting comprises a firm binding, firm knotting or adhesive bonding.

In this mounted state, the two rope sections are configured as a disturbing edge. A disturbing edge in this case is an aerodynamic disturbing geometry which disturbs the aerodynamics of the rotor blade, that is to say, for example, at least partially reduces or prevents a laminar wind current around the rotor blade. The disturbing edge is configured, for example, in such a way that vortices which interrupt an optimum flow around the rotor blade are generated at the disturbing edge. Therefore, an incident flow scenario for the rotor blade which does not correspond to the optimum incident flow scenario for which the shape of the rotor blade was designed is created in a targeted manner by the disturbing edge.

A device according to the present disclosure furthermore comprises a fastening arrangement comprising a plurality of fastening means. This fastening arrangement is configured to provide the mounting of the device, in one example of the two rope sections, on the rotor blade in the mounted state.

The disturbing edge is configured to be attachable in a region of the rotor blade leading edge. The region of the rotor blade leading edge in this case extends from the rotor blade leading edge preferably at a maximum up to half the rotor blade chord. Configured to be attachable in this region means that the disturbing edge has properties which do not prevent the disturbing edge from being attached at least partially in the region of the rotor blade leading edge in the mounted state. Preferably, the entire disturbing edge is attached in the region of the rotor blade leading edge in the mounted state.

It was found that the exact position of the disturbing edge in the region of the rotor blade leading edge has effects on the effect of the disturbing edge on the generated lift polars at the respective rotor blade section. In one example, this depends on the position of the disturbing edge on the suction side and/or pressure side. On the suction side, the disturbing edge has a primary effect on the polar of the positive stall point, the point from which stall occurs on the suction side. On the pressure side, the disturbing edge has a primary effect on the polar of the negative stall point, the point from which stall occurs on the pressure side. In this case, a position of the disturbing edge on the suction side influences, in one example the positive stall region, and correspondingly the negative stall region on the pressure side.

The two rope sections are arranged as a disturbing edge in such a way that they have a plurality of connection points spaced apart from one another such as in a direction along the rotor blade leading edge in the direction of the rotor blade tip. At these connection points, the two rope sections are in each case connected to one another. This is already provided by simple contact between the rope sections, for example by the two rope sections lying one on top of the other. In further exemplary embodiments, this connection comprises fastening, for example by sewing or knotting. It is likewise conceivable for the two rope sections to be part of a prefabricated net structure.

In each case at least one of the plurality of fastening means is arranged on the disturbing edge between two adjacent connection points. In one example, this at least one of the plurality of fastening means is arranged on one of the two rope sections. An exemplary embodiment is preferred in which always one fastening means is arranged on the disturbing edge between two adjacent connection points in each case. In this exemplary embodiment, it is furthermore preferred that always two adjacent fastening means arranged on the disturbing edge are attached to different ones of the two rope sections.

The fastening means are arranged on the disturbing edge in such a way that the fastening arrangement spans the two rope sections in the mounted state in the rotor blade chord direction, and in one example temporarily fasten, the disturbing edge in the region of the rotor blade leading edge. Preferably, the fastening arrangement spans the two rope sections over the surface of the rotor blade in substantially the rotor blade chord direction. Substantially the rotor blade chord direction in this case means that, as a result of the curved shape and thickness of the rotor blade, a resulting direction in which the disturbing edge is spanned deviates from the rotor blade chord direction.

Spanning in this case means that, in the mounted state, a tension is applied to the two rope sections, that is to say the two rope sections are not completely loose, in a relaxed state.

The fastening of the disturbing edge in the region of the rotor blade leading edge brought about by the fastening arrangement in the mounted state implies that the disturbing edge cannot be removed from the region of the rotor blade leading edge, for example by external forces such as gravity or forces induced by incident wind flow, without the fastening being released. Preferably, the fastening is configured temporarily and furthermore preferably also reversibly. This means that, after the fastening has been removed, the rotor blade is in a substantially identical state as before the fastening. Substantially identical in this case means that, for example, adhesive residues or discolorations of the rotor blade brought about by the fastening are dispensed with. The same state therefore relates primarily to the aerodynamics of the rotor blade.

The present disclosure is based on the knowledge that it is expedient for the reduction of pivoting oscillations to change aerodynamic profile polars in a specific rotor blade section, in this case in the outer region of a rotor blade (at >50% radius), in a targeted manner. The present disclosure is furthermore based on the knowledge that an aerodynamic excitation occurs in the pivoting direction in a region of the profile polars in which there is a negative lift gradient with in each case increasing angles of attack in terms of absolute value. This negative lift gradient is decisive for the direction of the action of an aerodynamic force. If the lift gradient is negative, an aerodynamic force always acts in the direction of movement of the rotor blade during pivoting movements which occur and would intensify the pivoting oscillation. If, by contrast, the lift gradient is positive in this region, the aerodynamic force would act counter to the direction of movement of the rotor blade and damp a potential pivoting oscillation. A lift gradient of zero would also still be expedient since at least no aerodynamic excitation would take place and the pivoting movement of the rotor blade would decay as a result of the inherent structural damping.

A device according to the present disclosure suppresses strongly negative lift gradients in the outer region of the rotor blades. On the basis of simulations, it has been shown that this suppression of the strongly negative lift gradient leads to an absence and thus suppression of pivoting oscillations of the rotor blade. The effectiveness of the device has likewise already been demonstrated on the polar plane in the wind tunnel.

According to an example embodiment of one aspect of the present disclosure, the disturbing edge is configured as a plurality of diamond shapes arranged next to one another. In one example, in each case one connection point of the two rope sections lies between the diamond shapes. In this case, every two adjacent connection points are spaced apart from one another by a diamond shape. For example, two rope sections cross at the connection points and are spanned between each two connection points by fastening means of the fastening arrangement to form the diamond shape. Alternatively, it is likewise possible for the disturbing edge to be configured rigidly in such a way that not each of the diamond shapes arranged next to one another is spanned by a fastening means of the fastening arrangement, but rather the shape is provided by the rigidity of the disturbing edge.

The region delimited by the two rope sections on the surface of the rotor blade therefore substantially has the shape of a plurality of diamond shapes arranged next to one another. In this case, substantially diamond shape means that, in some exemplary embodiments, the diamond shape comprises roundings caused, for example, by the curvature of the rotor blade surface.

The plurality of diamond shapes arranged next to one another increases the robustness of the disturbing edge. Furthermore, a continuous effect of the disturbing edge over a region of the rotor blade along which the disturbing edge is arranged is thus provided.

According to an example embodiment, each of the plurality of diamond shapes arranged next to one another has four corners, each of the plurality of diamond shapes arranged next to one another is connected at at least one corner to a further one of the plurality of diamond shapes arranged next to one another, and each of the plurality of diamond shapes arranged next to one another is connected at a maximum of two corners to a further one of the plurality of diamond shapes arranged next to one another. In this case, a corner is to be understood geometrically and is realized, for example, by a bend in a rope section. Likewise, the connection of two diamond shapes arranged next to one another at a corner is to be understood geometrically, for example in such a way that no physical fastening is necessary, but rather a superposition of the two rope sections at a connection point is sufficient. In this example, the connection point of the rope sections represents the connection of the diamond shapes arranged next to one another.

Each of the plurality of diamond shapes arranged next to one another is connected at a maximum of two corners to a further one of the plurality of diamond shapes arranged next to one another. In one example, the plurality of diamond shapes arranged next to one another are arranged next to one another along a direction, that is to say as a row of diamond shapes.

According to an example embodiment, the diamond shapes in the mounted state have an extent in the rotor blade chord direction which is in one example between 2% and 20% of the rotor blade chord, preferably approximately 10% of the rotor blade chord, and a width in the rotor blade longitudinal direction which is more than twice the extent in the rotor blade chord direction, in one example more than 4% of the rotor blade chord, preferably approximately 20% of the rotor blade chord.

The extent of the diamond shapes in the rotor blade chord direction is to be understood in one example as an extent substantially in the rotor blade chord direction. Substantially in the rotor blade chord direction in this case means that the direction deviates at least partially from the rotor blade chord direction as a result of the curvature and thickness of the rotor blade.

The width in the rotor blade longitudinal direction is to be understood in one example as a width substantially in the rotor blade longitudinal direction. Substantially in the rotor blade longitudinal direction in this case means that the direction deviates at least partially from the rotor blade longitudinal direction as a result of the shape of the rotor blade, for example as a result of curvature.

A wider example embodiment of the diamonds may be advantageous for thicker profiles, with the result that the width of the diamonds can be up to 100% of the chord.

According to an example embodiment, the rotor blade has a rotor blade profile thickness perpendicular to the rotor blade longitudinal direction and perpendicular to the rotor blade chord direction and the diamond shapes in the mounted state have a width in the rotor blade longitudinal direction which corresponds to at least half the rotor blade profile thickness. This variant is likewise advantageous for thicker rotor blade profiles.

According to an example embodiment of one aspect of the present disclosure, the rope sections are knotted, adhesively bonded and/or fastened to one another at the connection points. This increases the robustness of the disturbing edge and promotes a consistent effect of the disturbing edge since relative movements of the rope sections with respect to one another are thus reduced or suppressed at the connection points.

According to an example embodiment of one aspect of the present disclosure, the fastening arrangement is a fastening arrangement spanning the rotor blade. In this case, spanning the rotor blade means that, in the mounted state, at least a part of the rotor blade, preferably a predominant part of the rotor blade, is spanned at least locally. In this case, it is not necessary for the entire rotor blade to be spanned, for example, in exemplary embodiments, the region of the surface of the rotor blade in contact with the disturbing edge is not spanned by the fastening arrangement. Preferably, the fastening arrangement is attached to the disturbing edge at at least two points in the mounted state and spans the rotor blade between these two points.

In some exemplary embodiments, the fastening arrangement comprises a tensioning element, for example a rope tensioner, by means of which a tension of the fastening arrangement around the rotor blade can be brought about or intensified.

According to an example embodiment, the fastening arrangement is configured such that in the mounted state it extends from at least one contact point on the rotor blade trailing edge over the suction side up to the disturbing edge and extends from the contact point over the pressure side up to the disturbing edge.

The contact point accordingly represents a resistance which the fastening arrangement uses to fasten the disturbing edge to the rotor blade. In other words, the rotor blade exerts a force on the fastening arrangement in the rotor blade chord direction at the contact point and, according to the actio-reactio principle, the fastening arrangement exerts a force on the rotor blade at the contact point. The fastening arrangement uses this force to press the disturbing edge against the surface of the rotor blade. In one example, temporary fastening is produced in the mounted state as a result of resulting frictional resistance forces between the disturbing edge, the fastening arrangement and the surface of the rotor blade.

In exemplary embodiments in which the disturbing edge is arranged only on one of the suction side and the pressure side, the fastening arrangement in the mounted state extends from the contact point over that of the two sides on which the disturbing edge is not arranged over the leading edge up to the disturbing edge.

According to one example, the rotor blade has a plurality of serrations arranged on the rotor blade trailing edge, wherein the fastening arrangement is configured such that in the mounted state at least one of the contact points is arranged between two of the plurality of serrations.

Serrations are understood to be trailing edge elements which are arranged on the trailing edge of the rotor blade for the aerodynamic and/or aeroacoustic optimization of the rotor blade. Serrations usually have a triangular shape which tapers to a point, but deviations from this shape are also known. A serration base is present between each two such serrations. In this example, at least one of the contact points lies in such a serration base.

This makes it possible to attach a device according to the present disclosure even in rotor blade sections with serrations, that is to say serrations on the rotor blade trailing edge, without additional elements or changes to the device being necessary.

In addition, the serrations represent an additional anchoring of the device against movement in the rotor blade longitudinal direction. If a contact point lies between two serrations, the extent of the serrations in the rotor blade chord direction in the mounted state in which the fastening arrangement spans the disturbing edge prevents a movement of the contact point in the rotor blade longitudinal direction along the rotor blade trailing edge.

The stability of the device according to the present disclosure is thus increased in this example.

According to an example embodiment of one aspect of the present disclosure, the thickness of a first rope section of the two rope sections and/or of a second rope section of the two rope sections is a value between 1% of a local rotor blade chord and 2% of the local rotor blade chord. This leads to an optimized effect of the disturbing edge.

It was therefore found that the effect of the disturbing edge depends on the thickness of the rope sections. Thicker rope sections further intensify the effect of the disturbing edge, with the result that an increase in the thickness of the rope sections leads to an optimization of the effect of the disturbing edge in the case of an increase in the chord.

A local rotor blade chord is understood to be a rotor blade chord at the location of the disturbing edge, or at a local position on the rotor blade. If the disturbing edge extends over a rotor blade region, it can be assumed that the local rotor blade chord also changes over this rotor blade region.

According to an example embodiment of one aspect of the present disclosure, both of the rope sections have an identical thickness. This promotes a homogeneous effect of the disturbing edge over the rotor blade region on which it is arranged. In one example, this is an identical local thickness. In exemplary embodiments in which the thickness of the rope sections in the mounted state varies in the rotor blade longitudinal direction, it varies identically for both rope sections, with the result that they have an identical local thickness.

According to an example embodiment of one aspect of the present disclosure, the fastening arrangement comprises a rigid element and an elastic element, wherein in one example the rigid element in the mounted state is arranged on one of the pressure side and the suction side and the elastic element in the mounted state is arranged on one of the pressure side and the suction side on which the at least one rigid element is not arranged.

In order to fasten the disturbing edge to the rotor blade, the rigid element and the elastic element are in each case connected to the disturbing edge. In addition, the elastic element is stretched and a connection is produced between the elastic element and the rigid element via the rotor blade trailing edge. In the mounted state, a force therefore acts counter to the stretching of the elastic element, with the result that the fastening arrangement is configured to provide improved tensioning of the rope sections.

The rigid element improves the handling of the device, since no stretching forces are present when the fastening arrangement with the rigid element is attached to the disturbing edge and arranged on the rotor blade. An element which in the mounted state is configured to be rigid at least in the chord direction along the surface of the rotor blade is understood to be a rigid element. The elastic element in the mounted state is configured to be elastic at least in the chord direction along the surface of the rotor blade.

In alternative example embodiments, the fastening arrangement comprises further rigid or elastic elements which in the mounted state are arranged in each case on one of the pressure side or suction side. For example, a plurality of elastic elements on the suction side and pressure side provide improved homogeneous distribution of the forces acting on the rotor blade by the device.

According to an example embodiment, the elastic element is dimensioned such that a force between 10 N and 200 N, in one example between 20 N and 40 N, acts on the elastic element in the mounted state. This tensioning force provides sufficient fastening of the disturbing edge, with the result that movements of the latter are prevented as far as possible. Excessively strong tensioning forces possibly in turn have a negative effect on the rotor blade and possibly cause damage to the rotor blade.

According to an example embodiment of one aspect of the present disclosure, the fastening arrangement comprises at least one positioning element which is configured as a local enlargement of the fastening arrangement, wherein the at least one positioning element is configured to avoid a displacement of the fastening arrangement over the rotor blade trailing edge.

Such a local enlargement is, for example, a local thickening of the fastening arrangement. Preferably, in this case, a material is used which has additional anti-slip properties with regard to the surface of the rotor blade, for example an increased coefficient of friction.

In this case, the positioning element is configured such that it cannot be moved over the rotor blade trailing edge in the mounted state. A displacement of the fastening arrangement and of the device in the mounted state in the rotor blade chord direction is thus prevented.

This increases the stability of the device and ensures a consistent effect of the device.

According to an example embodiment of one aspect of the present disclosure, the fastening arrangement comprises at least one load distribution element, in one example a tarpaulin element, for radial load distribution in the rotor blade longitudinal direction in the mounted state, wherein the at least one load distribution element is configured to be connectable to at least one of the plurality of fastening means, in one example to each of the plurality of fastening means.

The load distribution element is configured, in one example, as a tarpaulin element with preferably greater extent in the rotor blade longitudinal direction than in the rotor blade chord direction in the mounted state. The load distribution element is configured to distribute loads acting locally on the fastening arrangement over a further region of the fastening arrangement. This increases the stability and robustness of the fastening arrangement.

Preferably, the load distribution element is configured to be connectable to a plurality of fastening means, in one example to each of the plurality of fastening means, with the result that loads acting on individual fastening means are distributed over a wider region of the fastening arrangement.

According to an example embodiment, the fastening arrangement comprises a plurality of connecting elements and the at least one load distribution element has a width in the rotor blade chord direction and is configured to be connectable to the plurality of connecting elements, wherein each of the plurality of connecting elements in the mounted state in each case has at least one contact point on the rotor blade trailing edge and a distance in the rotor blade longitudinal direction to further ones of the plurality of connecting elements, wherein the distance is at least 200% of a width of the load distribution element in the rotor blade chord direction.

In this case, the connecting elements are configured to connect the load distribution element to further elements of the fastening arrangement or of the disturbing edge via the rotor blade trailing edge. In this case, the load distribution element allows a smaller number of contact points with the trailing edge as a result of the load distribution. The number of contact points can be reduced to a value which, in the case of uniform distribution over the rotor blade region on which the disturbing edge is arranged, provides a contact point every at least 200% of the width of the load distribution element in the rotor blade chord direction.

This allows simpler mounting of the device on the rotor blade.

According to an example embodiment, the fastening arrangement comprises: a first load distribution element, in one example a first tarpaulin element on the suction side, a second load distribution element, in one example a second tarpaulin element on the pressure side, and a plurality of connecting elements, wherein each of the plurality of connecting elements is configured to connect the first load distribution element and the second load distribution element, wherein each of the plurality of connecting elements between the first load distribution element and the second load distribution element has at least one contact point on the rotor blade trailing edge.

This provides improved load distribution on the fastening arrangement both on the pressure side and on the suction side.

According to an example embodiment, the rotor blade has a plurality of serrations arranged on the rotor blade trailing edge, wherein each of the plurality of connecting elements is configured such that in the mounted state the at least one contact point is arranged between two of the plurality of serrations.

This provides improved fastening by the fastening arrangement, since a movement of the connecting elements along the rotor blade trailing edge is prevented by the extent of the serrations in the rotor blade chord direction.

According to an example embodiment, at least one of the plurality of connecting elements comprises a first positioning element and a second positioning element, such that in the mounted state the first positioning element is arranged on the suction side and the second positioning element is arranged on the pressure side, wherein the first positioning element and the second positioning element are configured as local enlargements of the at least one connecting element, and that the first positioning element and the second positioning element are configured to avoid a displacement of the at least one connecting element over the rotor blade trailing edge.

Such a local enlargement is, for example, a local thickening of the connecting element. Preferably, in this case, a material is used which has additional anti-slip properties with regard to the surface of the rotor blade, for example an increased coefficient of friction.

In this case, the positioning element is configured such that it cannot be moved over the rotor blade trailing edge in the mounted state. A displacement of the connecting elements, of the load distribution element and of the device in the mounted state in the rotor blade chord direction is thus prevented.

This increases the stability of the device and ensures a consistent effect of the device.

According to an example embodiment of one aspect of the present disclosure, each of the plurality of fastening means is configured to be individually releasable in the mounted state, comprising at least one release element configured for individually releasing each of the plurality of fastening means, wherein the release element is configured such that the individual release of each of the plurality of fastening means can be carried out from a distance to the plurality of fastening means, wherein the distance corresponds at least to the rotor blade length.

Preferably, the device comprises a release element which is configured for individually releasing each of the plurality of fastening means. Alternatively, the device comprises a plurality of release elements, wherein each is configured for individually releasing one or more of the plurality of fastening means.

A state in which each of the plurality of fastening means is released is not a mounted state. A state in which each of the plurality of fastening means is not released, but is configured to be releasable, is a mounted state. The releaseability of the fastening means represents a possibility for removing the device from the rotor blade, with the result that temporarily, in one example reversibly, fastening of the device to the rotor blade is provided.

Preferably, the release of the fastening means does not include the destruction or damaging thereof. In this case, the release is possible from a distance which corresponds at least to the blade length. For example, the release can be effected by pulling on a long rope or sending a command via a wireless connection to a receiver. The release element is configured, for example, as a cord, rope, carabiner or clamp.

Examples of release elements are “slip” nodes introduced into fastening means, remotely releasable carabiners, pull-out plug-in or locking elements (e.g. transverse pin made of metal or line as a continuous “key line”) or a microtoothed geometry (e.g. zip fastener).

This allows simpler release of the mounted state and removal of the device from the rotor blade.

According to an example embodiment of one aspect of the present disclosure, the device comprises at least one protective element configured for enclosing at least one part of the fastening arrangement. Preferably such that, in the mounted state, there is increased protection for the enclosed part of the fastening arrangement, for example against weather influences.

According to an example embodiment, the at least one protective element is configured as one or more flaps or one or more tabs and comprises a closure, in one example one or more hook-and-loop fasteners or one or more push buttons.

In this case, the one or more flaps or one or more tabs are configured such that they are placed around the part of the fastening arrangement in the mounted state and thus enclose this part. The closure ensures that this enclosing is not released by external influences and the protection of the protective element continues to exist.

According to a second aspect of the present disclosure, the object is achieved by a method for temporarily fastening a device for avoiding induced rotor blade oscillations to a rotor blade of a wind turbine, wherein the rotor blade extends from a rotor blade root in the rotor blade longitudinal direction with a rotor blade length to the rotor blade tip and from a rotor blade leading edge with a rotor blade chord in the rotor blade chord direction perpendicular to the rotor blade longitudinal direction to a rotor blade trailing edge and has a suction side and a pressure side, wherein the device comprises two rope sections which are configured to act as a disturbing edge in a mounted state in which the device is mounted on the rotor blade, a fastening arrangement comprising a plurality of connecting elements, wherein the rotor blade has a plurality of serrations arranged on the rotor blade trailing edge, the disturbing edge is configured to be attachable to the rotor blade in a region of the rotor blade leading edge, the fastening arrangement is configured to be attachable to the disturbing edge, comprising the following steps: arranging the disturbing edge on the rotor blade; attaching the fastening arrangement to the disturbing edge on one of the suction side or the pressure side; guiding the plurality of connecting elements from one of the suction side or the pressure side to another of the suction side or the pressure side over the rotor blade trailing edge such that each of the plurality of connecting elements runs between two of the plurality of serrations; fastening the device to the rotor blade by attaching the fastening arrangement on the other of the suction side or the pressure side to the disturbing edge.

The step of arranging the disturbing edge on the rotor blade comprises, for example, bringing it into contact and/or placing it against it.

The step of attaching the fastening arrangement to the disturbing edge on one of the suction side or the pressure side comprises, for example, connecting the fastening arrangement to the disturbing edge and/or fastening the fastening arrangement to the disturbing edge.

After the step of guiding, the device leads around the rotor blade.

The step of attaching the fastening arrangement on the other side produces the mounted state by the rope sections being spanned around the rotor blade by the fastening arrangement. This produces the fastening of the device to the rotor blade.

The method according to the present disclosure represents a simple method for temporarily and robustly fastening a device for avoiding induced rotor blade oscillations to a rotor blade of a wind turbine.

According to the present disclosure, it is possible to temporarily fasten each of the described configurations and variants of the device according to the first aspect and also further configurations and variants, not described, of a device according to the present disclosure to a rotor blade of a wind turbine by a method according to the present disclosure.

In exemplary embodiments, a method according to the present disclosure comprises additional steps before, between and/or after the method steps explicitly listed above.

Features of advantageous example embodiments of the present disclosure are defined in one example in the dependent claims, wherein further advantageous features, example embodiments and configurations can also be gathered for the person skilled in the art from the above explanation and the following discussion.

### BRIEF DESCRIPTION OF THE DRAWINGS

The present disclosure is illustrated and explained further below on the basis of exemplary embodiments illustrated in the figures. In this case,

FIG. 1 illustrates a schematic illustration of a wind turbine,

FIG. 2 illustrates a schematic illustration of a wind farm,

FIG. 3 illustrates a schematic illustration of a lift polar diagram of a rotor blade,

FIG. 4 illustrates a schematic illustration for illustrating a first exemplary embodiment of the disturbing edge,

FIG. 5 illustrates a schematic illustration for illustrating the first exemplary embodiment of the disturbing edge,

FIG. 6 illustrates a schematic illustration for illustrating a first exemplary embodiment of the device according to the present disclosure,

FIG. 7 illustrates a schematic illustration for illustrating a second exemplary embodiment of the device according to the present disclosure,

FIG. 8 illustrates a schematic illustration for illustrating a part of a third exemplary embodiment of the device according to the present disclosure,

FIG. 9 illustrates a schematic flow diagram of an exemplary embodiment of the method according to the present disclosure.

### DETAILED DESCRIPTION

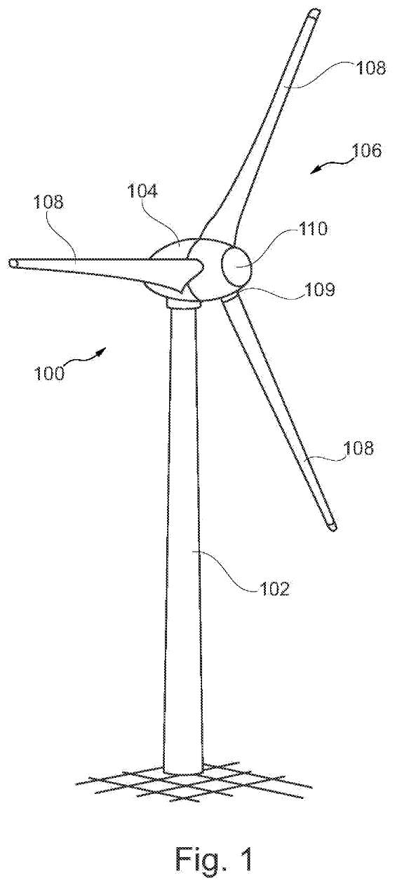

FIG. 1 illustrates a schematic illustration of a wind turbine according to the present disclosure. The wind turbine 100 has a tower 102 and a nacelle 104 on the tower 102. An aerodynamic rotor 106 with three rotor blades 108 and a spinner 110 is provided on the nacelle 104. During operation of the wind turbine, the aerodynamic rotor 106 is set into a rotational movement by the wind and thus also rotates an electrodynamic rotor or rotor of a generator which is coupled directly or indirectly to the aerodynamic rotor 106. The electrical generator is arranged in the nacelle 104 and generates electrical energy. The pitch angles of the rotor blades 108 can be changed by pitch motors at the rotor blade roots 109 of the respective rotor blades 108.

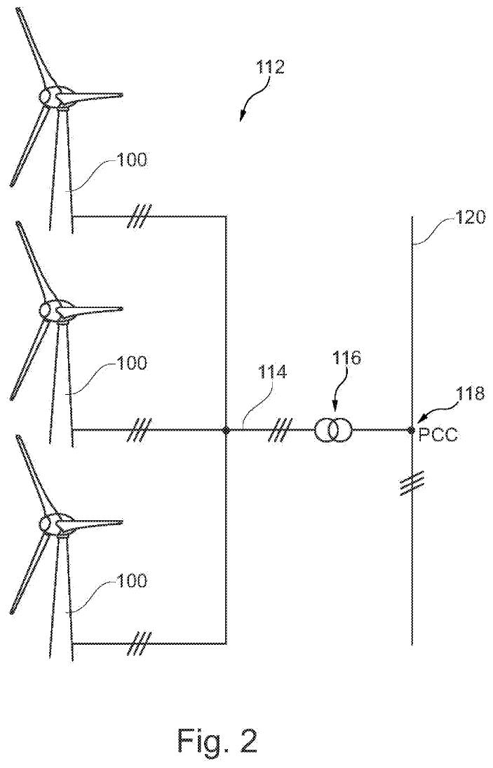

FIG. 2 illustrates a wind farm 112 with, by way of example, three wind turbines 100 which can be identical or different. The three wind turbines 100 are thus representative of basically any desired number of wind turbines of a wind farm 112. The wind turbines 100 provide their power, in one example the generated current, via an electrical farm grid 114. In this case, the respectively generated currents or powers of the individual wind turbines 100 are added up and, in most cases, a transformer 116 is provided which steps up the voltage in the farm in order then to feed it into the supply grid 120 at the feed-in point 118, which is also generally referred to as PCC. FIG. 2 is only a simplified illustration of a wind farm 112. By way of example, the farm grid 114 can be configured differently by virtue of, for example, also a transformer being present at the output of each wind turbine 100, in order to mention just one other exemplary embodiment.

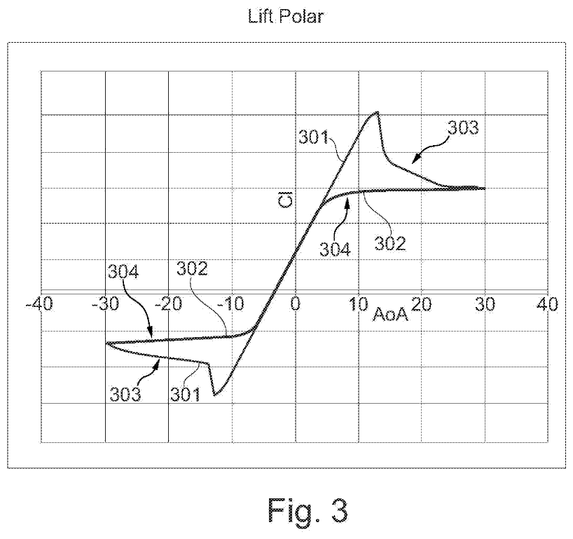

FIG. 3 illustrates a schematic illustration of a lift polar diagram of a rotor blade, more precisely of a rotor blade segment of an outer region of the rotor blade (>50% rotor blade radius). Shown are two curves, a lift polar without modification 301 and a lift polar with modification 302, plotted over different angles of attack. The modification is a modification of the rotor blade by attaching a device according to the present disclosure. Both curves 301, 302 show the greatest aerodynamic excitation at angles of attack between +20° and +40° and between −20° and −40°. The profile polars of the lift polar without modification 301 have a strongly negative lift gradient 303 in this angle of attack region. This leads to excitations of the rotor blade which, for example, induce pivoting oscillations.

It has now been found that by attaching a device according to the present disclosure to the rotor blade, these strongly negative lift gradients 303 are eliminated such that there is a positive lift gradient 304 in the lift polar with modification 302 in said angle of attack regions, which positive lift gradient does not negatively excite the rotor blade such that pivoting oscillations occur. In one example, no negative lift gradients occur after the stall has occurred. The stall also takes place significantly more gently and earlier and is characterized in that the lift gradient is extremely reduced at the end of the so-called “linear branch” of the polar. The lift therefore no longer increases linearly with the angle of attack after the stall has occurred.

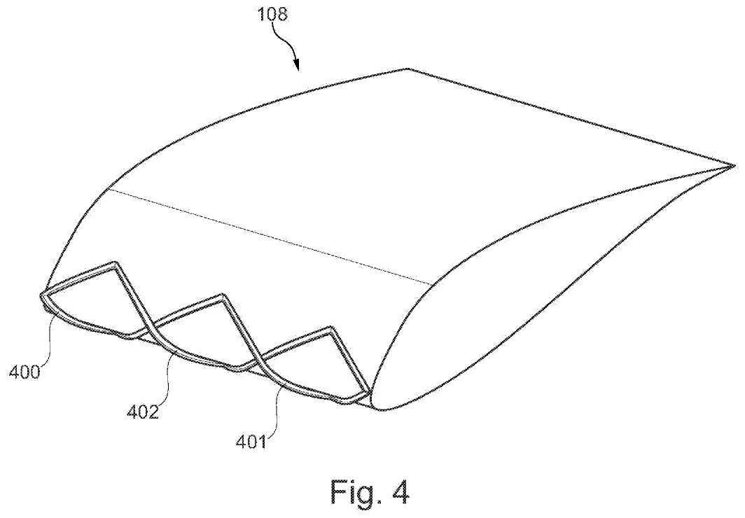

FIG. 4 illustrates a schematic illustration for illustrating a first exemplary embodiment of the disturbing edge 400, arranged on a rotor blade segment of a rotor blade 108. The disturbing edge 400 is arranged in the region of the leading edge of the rotor blade in order to achieve the polar modification from FIG. 3. The disturbing edge 400 can consist of ropes or similar flexible or rigid structures, or comprise them. In this exemplary embodiment, the disturbing edge comprises a first rope section 401 and a second rope section 402, which are arranged one above the other in a zigzag pattern in such a way that a diamond shape of the disturbing edge 400 is produced. This shape provides a robust possibility of attachment to the rotor blade and a greater range of action with regard to the influenced angle of attack regions in comparison with previously known solutions. The rope sections 401, 402 cross one another at a plurality of connection points 403. In this exemplary embodiment, the connection points 403 are produced merely by being placed one above the other. In alternative exemplary embodiments, the two rope sections 401, 402 are adhesively bonded, sewn and/or woven into one another at the connection points 403.

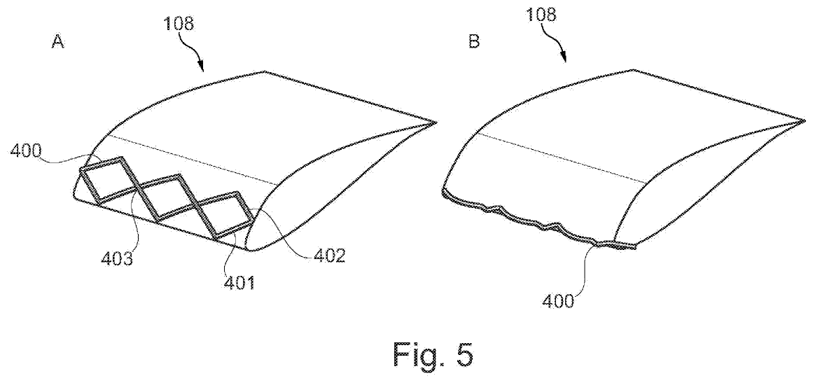

In this case, the diamond structure of the disturbing edge 400 can be displaced in the direction of the suction side or pressure side in accordance with the profile curvature in order to concentrate the influencing of the disturbing edge 400 on the polar on the negative or positive stall point, as shown in FIG. 5. In this case, a displacement on the suction side influences such as the positive stall region, and correspondingly the negative stall region on the pressure side. In this case, stall is to be understood as a synonym for flow separation.

In figure A of FIG. 5, the disturbing edge 400 is arranged on the suction side of the rotor blade 108 in the region of the leading edge. In figure B of FIG. 5, the disturbing edge 400 is arranged on the pressure side of the rotor blade 108 in the region of the leading edge. Depending on the rotor blade and the oscillation to be avoided, an optimum position of the disturbing edge 400 on the pressure side and/or suction side of the rotor blade is selected. This optimum position can be determined, for example, on the basis of a lift polar diagram of the rotor blade section to which the disturbing edge is to be attached.

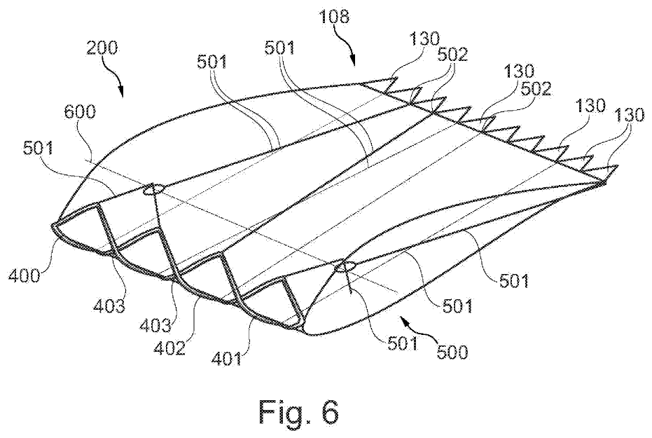

FIG. 6 illustrates a schematic illustration for illustrating a first exemplary embodiment of the device 200 according to the present disclosure. The disturbing edge 400 is arranged in a region of the leading edge of the rotor blade 108. The fastening arrangement 500 comprises a plurality of fastening means 501 which hold and fasten the disturbing edge 400 in position via contact points 502 on the rotor blade trailing edge between in each case two of a plurality of serrations 130. In this exemplary embodiment, the fastening means 501 are configured in two parts, in such a way that the two parts of a fastening means 501 are held together by a release element 600. In this exemplary embodiment, the release element 600 is configured as a rope, in such a way that the fastening means 501 are individually released when the release element is removed.

FIG. 6 illustrates the device 200 according to the present disclosure according to the first exemplary embodiment in the mounted state. This mounted state can be released by removing the release element 600. Accordingly, reversible and temporary fastening of the device 200 is present. In this mounted state, the fastening means 501 are guided from a connection point with the disturbing edge on the pressure side or suction side over the surface of the rotor blade 108 up to the rotor blade trailing edge and guided there around a respective serration 130 and then back over the same of the pressure side or suction side to a second connection point with the disturbing edge. As a result of the extent of the serrations 130 in the rotor blade chord direction and the presence of tension on each of the fastening means 501, there is fastening of the device 200 to the rotor blade 108. The serrations 130 prevent a radial movement of the fastening means 501 as a result of their extent in the rotor blade chord direction.

In this exemplary embodiment, the disturbing edge 400 comprises two rope sections 401, 402 which are connected at a plurality of connection points 403. Always one fastening means 501 is arranged between each two of these connection points 403 on the pressure side and on the suction side on the disturbing edge 400, with the result that the latter is spanned over the surface of the rotor blade 108 in the direction of the rotor blade trailing edge.

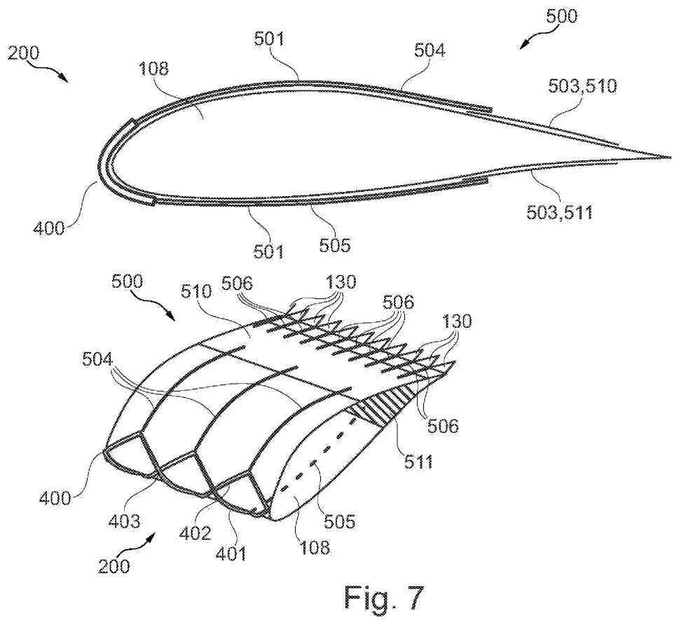

FIG. 7 illustrates a schematic illustration for illustrating a second exemplary embodiment of the device 200 according to the present disclosure. In this exemplary embodiment, the device 200 comprises a disturbing edge 400 and a fastening arrangement 500 comprising a plurality of fastening means 501 and two load distribution elements 503 in the form of tarpaulins, of which a first load distribution element 510 is arranged on the suction side of the rotor blade 108 and a second load distribution element 511 is arranged on the pressure side of the rotor blade 108. In this exemplary embodiment, the fastening means 501 comprise rigid elements 504 and elastic elements 505. The fastening arrangement 500 furthermore comprises a plurality of connecting elements 506.

The disturbing edge 400 is arranged in a region of the leading edge of a rotor blade section of the rotor blade 108. A plurality of rigid elements 504 are attached to the disturbing edge 400 on the suction side. These are in turn connected to the first load distribution element 510. The load distribution elements 503 are arranged in a region of the rotor blade trailing edge on the pressure side and suction side of the rotor blade 108, respectively. Both load distribution elements 510, 511 are in each case connected to the plurality of connecting elements 506. These connect the two load distribution elements 510, 511 via the rotor blade trailing edge. On the rotor blade trailing edge, each of the connecting elements 506 runs between two of a plurality of serrations 130. On the pressure side, the second load distribution element 511 is connected to a plurality of elastic elements 505. In order to ensure clarity, only one of these elastic elements 505 is shown in FIG. 7. The further elastic elements 505 run parallel to the elastic element 505 shown and connect the disturbing edge 400 to the second load distribution element 511. The elastic elements 505 connect the second load distribution element 511 to the disturbing edge 400. According to the present disclosure, the elasticity of the elastic elements 505 is configured such that they are stretched in order to connect the second load distribution element 511 and the disturbing edge 400, that is to say in order to produce the mounted state. As a result of this stretching in the mounted state, a force acts along the fastening arrangement 500 and contributes to the fastening of the device 200 to the rotor blade 108.

The elasticity of the elastic elements 505 in this case improves the fit of the device 200 on the rotor blade 108 as a result of the resulting prestressing, while the orientation of the disturbing edge 400 on the rotor blade 108 is ensured by the rigid elements 504. In alternative exemplary embodiments, combinations of the rigid and elastic elements over the suction side and pressure side are also present.

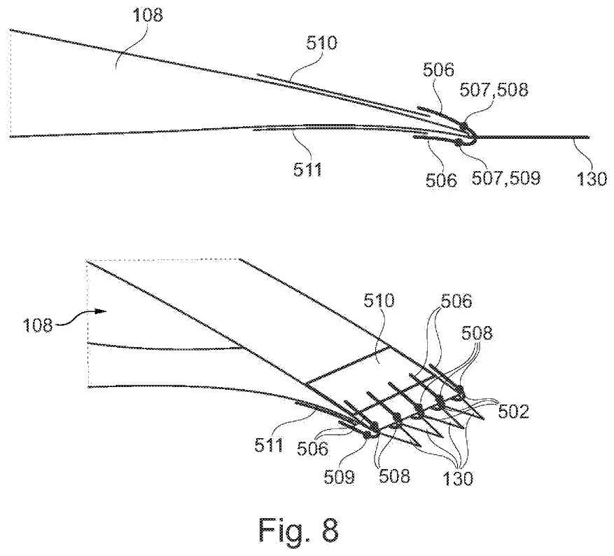

FIG. 8 illustrates a schematic illustration for illustrating part of a third exemplary embodiment of the device 200 according to the present disclosure. Only a detail of the region of the rotor blade trailing edge is shown in FIG. 8. However, in this exemplary embodiment, a device 200 according to the present disclosure is likewise attached to the rotor blade 108 in the mounted state. However, the focus of FIG. 8 is not on the disturbing edge 400, but rather on the load distribution elements 503, comprising a first load distribution element 510 and a second load distribution element 511 and in one example the connection thereof by connecting elements 506 via the rotor blade trailing edge, for which reason only these are shown. In this exemplary embodiment, the fastening arrangement 500 comprises two load distribution elements 510, 511 in the form of tarpaulins, the first load distribution element 510 being arranged on the suction side, the second load distribution element 511 being arranged on the pressure side of the rotor blade 108. The two load distribution elements 510, 511 are connected to one another via the rotor blade trailing edge via a plurality of connecting elements 506. In this case, each of the plurality of connecting elements 506 runs between in each case two of a plurality of serrations 130 which are attached to the trailing edge of the rotor blade 108. In this case, each of the plurality of connecting elements 506 has a contact point 502 with the rotor blade trailing edge between in each case two of the serrations 130.

In addition, each of the plurality of connecting elements 506 has in each case one local enlargement 507 on the pressure side and suction side in the form of positioning nodes. In this case, each of the plurality of connecting elements comprises a first positioning element 508 in the form of a local enlargement in the form of a node on the suction side and a second positioning element 509 in the form of a local enlargement in the form of a node on the pressure side of the rotor blade 108. These local enlargements prevent a movement of the connecting elements 506 over the rotor blade trailing edge. This ensures improved stability of the fastening arrangement 500.

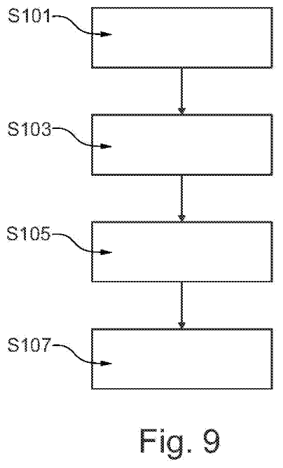

FIG. 9 illustrates a schematic flow diagram of an exemplary embodiment of the method according to the present disclosure for temporarily fastening a device for avoiding induced rotor blade oscillations to a rotor blade of a wind turbine.

Step S101 comprises arranging the disturbing edge on the rotor blade. For example, the disturbing edge is placed on a rotor blade at an installation site of a wind turbine, which rotor blade is not yet mounted on the wind turbine.

Step S103 comprises attaching the fastening arrangement to the disturbing edge on one of the suction side or the pressure side. For example, the disturbing edge is additionally optimized in terms of its position and/or shape by attaching the fastening arrangement. After attachment, the fastening arrangement serves as means for adapting a position and/or shape of the disturbing edge by pulling on the fastening arrangement.

Step S105 comprises guiding the plurality of connecting elements from the one of the suction side or the pressure side to another of the suction side or the pressure side over the rotor blade trailing edge such that each of the plurality of connecting elements runs between two of the plurality of serrations.

Step S107 comprises fastening the device to the rotor blade by attaching the fastening arrangement on the other of the suction side or the pressure side to the disturbing edge. This step S107 also comprises, for example, tightening the fastening arrangement or stretching at least parts of the fastening arrangement.

### REFERENCE SIGNS

100 wind turbine
102 tower
104 nacelle
106 rotor
108 rotor blade
109 rotor blade root
110 spinner
112 wind farm
114 farm grid
116 transformer
118 feed-in point
120 supply grid
130 serration
200 device
301 lift polar without modification
302 lift polar with modification
303 strongly negative lift gradient
304 positive lift gradient
400 disturbing edge
401 first rope section
402 second rope section
403 connection point
500 fastening arrangement
501 fastening means
502 contact point
503 load distribution element
504 rigid element
505 elastic element
506 connecting element
507 local enlargement of the connecting element
508 first positioning element
509 second positioning element
510 first load distribution element
511 second load distribution element
600 release element

1. A device for avoiding induced rotor blade oscillations of a rotor blade of a wind turbine, wherein the rotor blade extends from a rotor blade root in a rotor blade longitudinal direction with a rotor blade length to a rotor blade tip and from a rotor blade leading edge with a rotor blade chord in a rotor blade chord direction perpendicular to the rotor blade longitudinal direction to a rotor blade trailing edge and has a suction side and a pressure side, the device comprising
two rope sections which, in a mounted state in which the device is mounted on the rotor blade, are configured to act as a disturbing edge,
a fastening arrangement including a plurality of fastening means, wherein
the disturbing edge is configured to be attachable in a region of the rotor blade leading edge,
the two rope sections are connected to one another at a plurality of connection points spaced apart from one another, and
in each case at least one of the plurality of fastening means is arranged on the disturbing edge between two adjacent connection points of the plurality of connection points,
the fastening arrangement is configured to span the two rope sections in the mounted state in the rotor blade chord direction and fasten the disturbing edge in the region of the rotor blade leading edge.

2. The device according to claim 1, wherein the disturbing edge is configured as a plurality of diamond shapes arranged next to one another, wherein
each of the plurality of diamond shapes arranged next to one another has four corners,
each of the plurality of diamond shapes is connected to at least one other diamond shape of the plurality of diamond shapes via at least one corner of the four corners, and
each of the plurality of diamond shapes is connected to at the at least one other diamond shape at a maximum of two corners of the four corners.

3. The device according to claim 2, wherein the plurality of diamond shapes in the mounted state,
have an extent in the rotor blade chord direction which is between 2% and 20% of the rotor blade chord, and
have a width in the rotor blade longitudinal direction which is more than twice the extent in the rotor blade chord direction,
wherein the rotor blade has a rotor blade profile thickness perpendicular to the rotor blade longitudinal direction and perpendicular to the rotor blade chord direction and the plurality of diamond shapes in the mounted state have a width in the rotor blade longitudinal direction which corresponds to at least half the rotor blade profile thickness.

4. The device according to claim 1, wherein the rope sections are knotted, adhesively bonded, or fastened to one another at the connection points.

5. The device according to claim 1, wherein the fastening arrangement spans the rotor blade.

6. The device according to claim 5, wherein
the fastening arrangement is configured such that in the mounted state, the fastening arrangement extends from at least one contact point on the rotor blade trailing edge over the suction side up to the disturbing edge and extends from the contact point over the pressure side up to the disturbing edge, and
the rotor blade has a plurality of serrations arranged on the rotor blade trailing edge and the fastening arrangement is configured such that in the mounted state at least one of the contact points is arranged between two of the plurality of serrations.

7. The device according to claim 1, wherein
a thickness of a first rope section of the two rope sections or a thickness of a second rope section of the two rope sections is a value between 1% of a local rotor blade chord and 2% of the local rotor blade chord, and
the first rope section and the second rope section have an identical thickness.

8. The device according to claim 1, wherein
the fastening arrangement comprises a rigid element and an elastic element, wherein the rigid element in the mounted state is arranged on one of the pressure side and the suction side and the elastic element in the mounted state is arranged on one of the pressure side and the suction side on which the rigid element is not arranged, and the elastic element dimensioned such that a force between 10 N and 200 N acts on the elastic element in the mounted state.

9. The device according to claim 1, wherein
the fastening arrangement comprises at least one positioning element which is configured as a local enlargement of the fastening arrangement, and
the at least one positioning element is configured to avoid a displacement of the fastening arrangement over the rotor blade trailing edge.

10. The device according to claim 1, wherein
the fastening arrangement comprises at least one a tarpaulin element, for radial load distribution in the rotor blade longitudinal direction in the mounted state, and
the at least one load distribution element is configured to be connectable to at least one of the plurality of fastening means.

11. The device according to claim 10, wherein
the fastening arrangement comprises a plurality of connecting elements and the at least one load distribution element has a width in the rotor blade chord direction and is configured to be connectable to the plurality of connecting elements,
each of the plurality of connecting elements in the mounted state has at least one contact point on the rotor blade trailing edge and a distance in the rotor blade longitudinal direction to further ones of the plurality of connecting elements, the distance being at least 200% of a width of the load distribution element in the rotor blade chord direction,
the fastening arrangement includes:
a first load distribution element on the suction side,
a second load distribution element on the pressure side, and
a plurality of connecting elements,
each of the plurality of connecting elements is configured to connect the first load distribution element and the second load distribution element, and
each of the plurality of connecting elements between the first load distribution element and the second load distribution element has at least one contact point on the rotor blade trailing edge.

12. The device according to claim 11, wherein
the rotor blade has a plurality of serrations arranged on the rotor blade trailing edge, wherein each of the plurality of connecting elements is configured such that in the mounted state the at least one contact point is arranged between two of the plurality of serrations,
at least one of the plurality of connecting elements includes a first positioning element and a second positioning element, such that in the mounted state the first positioning element is arranged on the suction side and the second positioning element is arranged on the pressure side, and
the first positioning element and the second positioning element are configured as local enlargements of the at least one connecting element, and that the first positioning element and the second positioning element are configured to avoid a displacement of the at least one connecting element over the rotor blade trailing edge.

13. The device according to claim 1, wherein
each of the plurality of fastening means is configured to be individually releasable in the mounted state,
at least one release element configured for individually releasing each of the plurality of fastening means,
the release element is configured such that the individual release of each of the plurality of fastening means is carried out from a distance to the plurality of fastening means, and
the distance corresponds at least to the rotor blade length.

14. The device according to claim 1, further comprising:
at least one protective element configured for enclosing at least one part of the fastening arrangement, wherein the at least one protective element is configured as one or more flaps or one or more tabs and includes a closure, the closure being one or more hook-and-loop fasteners or one or more push buttons.

15. A method for temporarily fastening a device for avoiding induced rotor blade oscillations to a rotor blade of a wind turbine, wherein the rotor blade extends from a rotor blade root in a rotor blade longitudinal direction with a rotor blade length to a rotor blade tip and from a rotor blade leading edge with a rotor blade chord in a rotor blade chord direction perpendicular to the rotor blade longitudinal direction to a rotor blade trailing edge and has a suction side and a pressure side, wherein the device includes
two rope sections which, in a mounted state in which the device is mounted on the rotor blade, are configured to act as a disturbing edge,
a fastening arrangement comprising a plurality of connecting elements, wherein
the rotor blade has a plurality of serrations arranged on the rotor blade trailing edge,
the disturbing edge is configured to be attachable to the rotor blade in a region of the rotor blade leading edge,
the fastening arrangement is configured to be attachable to the disturbing edge,
the method comprising:
arranging the disturbing edge on the rotor blade;
attaching the fastening arrangement to the disturbing edge on one of the suction side or the pressure side;
guiding the plurality of connecting elements from the one of the suction side or the pressure side to another of the suction side or the pressure side over the rotor blade trailing edge such that each of the plurality of connecting elements runs between two of the plurality of serrations; and
fastening the device to the rotor blade by attaching the fastening arrangement on the other of the suction side or the pressure side to the disturbing edge.
